(19) United States
(12) Patent Application Publication
(10) Pub. No.: US 2019/0332904 A1
(43) Pub. Date: Oct. 31, 2019

(54) CARD ISSUING DEVICE

(71) Applicant: Shenzhen Tianyi Technology Co., Ltd., Shenzhen (CN)

(72) Inventors: Bin WU, Shenzhen (CN); Xiaodong QIAN, Shenzhen (CN); Kai LIU, Shenzhen (CN); Su RONG, Shenzhen (CN)

(21) Appl. No.: 16/396,037

(22) Filed: Apr. 26, 2019

(30) Foreign Application Priority Data
Apr. 28, 2018 (CN) 201810405097.2

(51) Int. Cl. G06K 13/103; G06K 13/08; G06K 13/14

(52) U.S. Cl. CPC G06K 13/103; G06K 13/14; G06K 13/0806

(57) ABSTRACT

An embodiment of the present invention provides a card issuing device, which includes a card storing mechanism, a transport mechanism, and a base. The transport mechanism is arranged in the base. The card storing mechanism is arranged above the transport mechanism. The card storing mechanism comprises a pressing block and a buckle. The transport mechanism comprises a guide rail and a card hook. The transport mechanism transports a card by cooperating of the guide rail and the card hook. The card storing mechanism fixes the card via the pressing block and the buckle. The base is configured to fix the card storing mechanism and the transport mechanism. According to the present invention, a card issuing box and a card receiving box are integrated into one body to reduce structural complexity, reduce costs, and improve space utilization rate.

### FIELD OF TECHNOLOGY

The present invention relates to the field of mechanical technologies, and more particularly, to a card issuing device.

### BACKGROUND

Electronic verification devices such as a K-Bao and a U-Shield greatly improve the security of online banking payment and thus are widely used in banking, service industries and so on.

To facilitate customers in handling businesses, self-service card issuing machines are provided by banks for the customers to handle self-service businesses. Each electronic verification device may be stored in a card box, when the card issuing machine issues a card, the card box is output from a card issuing port.

An existing card issuing machine typically has a card receiving box and a card issuing box, which are respectively use for receiving and issuing cards. However, the existing card issuing machine is low in space utilization rate, complex in structure, and high in cost.

### SUMMARY

An embodiment of the present invention provides a card issuing device, to solve the problem that a card issuing machine typically has a card receiving box and a card issuing box, which are respectively use for receiving and issuing cards, but the card issuing machine is low in space utilization rate, complex in structure, and high in cost.

To solve the above problem, an embodiment of the present invention discloses a card issuing device, which includes a card storing mechanism, a transport mechanism and a base. The transport mechanism is arranged in the base. The card storing mechanism is arranged above the transport mechanism. The card storing mechanism includes a pressing block and a buckle. The transport mechanism includes a guide rail and a card hook. The transport mechanism transports a card by cooperating of the guide rail and the card hook. The card storing mechanism fixes the card via the pressing block and the buckle. The base is configured to fix the card storing mechanism and the transport mechanism.

Preferably, the card storing mechanism further includes a box body, which includes a mounting plate, a front baffle, a box door, a right side plate, and a left side plate. The right side plate is connected to the mounting plate and the box door respectively. The left side plate is connected to the mounting plate and the box door respectively. The mounting plate is connected to the front baffle.

Preferably, the box body further includes a bottom plate and a top plate. The bottom plate is located below the front baffle, the right side plate and the left side plate, and is connected to the front baffle, the right side plate and the left side plate respectively. The top plate is located above the box door, the right side plate and the left side plate, and is connected to the box door, the right side plate and the left side plate respectively.

Preferably, the pressing block is connected to the mounting plate, and the pressing block moves along a length direction of the mounting plate. The buckle is arranged below the top plate, and the buckle is configured to unlock or lock the pressing block.

Preferably, the transport mechanism further includes a card issuing seat. A center of the card issuing seat has a strip-shaped groove. The guide rail is embedded on both sides of the strip-shaped groove, and the card hook slides via the guide rail.

Preferably, a card is placed on the card hook, and the card is transported to the card storing mechanism via the guide rail.

Preferably, the base includes a rack, a card receiving top block and driving wheel. The driving wheel is arranged above an initial position of the card hook, and the driving wheel is configured to cooperate with the card hook to transport the card to the card storing mechanism.

Preferably, the card receiving top block is arranged on both sides of the rack, and the card receiving top block is configured to push up the card in the card storing mechanism.

Preferably, the rack includes rack plates on both sides thereof, and the rack plate is configured to fix the card storing mechanism and the transport mechanism.

Preferably, the card storing mechanism further includes a card issuing baffle. the card issuing baffle is arranged in a card issuing port of the mounting plate, and the card issuing baffle is configured to prevent the card from slipping out of the card storing mechanism.

The embodiment of the present invention includes following advantages.

In the embodiment of the present invention, the card issuing device includes a card storing mechanism, a transport mechanism, and a base. The transport mechanism is arranged in the base. The card storing mechanism is arranged above the transport mechanism. The card storing mechanism comprises a pressing block and a buckle. The transport mechanism comprises a guide rail and a card hook. The transport mechanism transports a card by cooperating of the guide rail and the card hook. The card storing mechanism fixes the card via the pressing block and the buckle. The base is configured to fix the card storing mechanism and the transport mechanism. According to the present invention, a card issuing box and a card receiving box are integrated into one body to reduce structural complexity, reduce costs, and improve space utilization rate.

### BRIEF DESCRIPTION OF THE DRAWINGS

FIG. 1 is a structural block diagram of a card issuing device according to an embodiment of the present invention;

FIG. 2 is an interior view of a base according to an embodiment of the present invention;

FIG. 3 is a structural block diagram of a card issuing device according to an embodiment of the present invention;

FIG. 4 is a side view of a card issuing device according to an embodiment of the present invention;

FIG. 5 is a front view of a card issuing device according to an embodiment of the present invention;

FIG. 6 is a structural block diagram of a transport mechanism according to an embodiment of the present invention;

FIG. 7 is a structural block diagram of a transport mechanism according to an embodiment of the present invention;

FIG. 8 is a structural block diagram of a card storing mechanism according to an embodiment of the present invention;

FIG. 9 is a side view of a card storing mechanism according to an embodiment of the present invention;

FIG. 10 is a structural block diagram of a card storing mechanism according to an embodiment of the present invention;

FIG. 11 is a partial view of a card storing mechanism according to an embodiment of the present invention; and

FIG. 12 is a structural block diagram of a base according to an embodiment of the present invention.

### DESCRIPTION OF THE EMBODIMENTS

To make the foregoing objectives, features, and advantages of the embodiments of the present invention more apparent and lucid, the embodiments of the present invention are further described in detail below with reference to the accompanying drawings and specific embodiments.

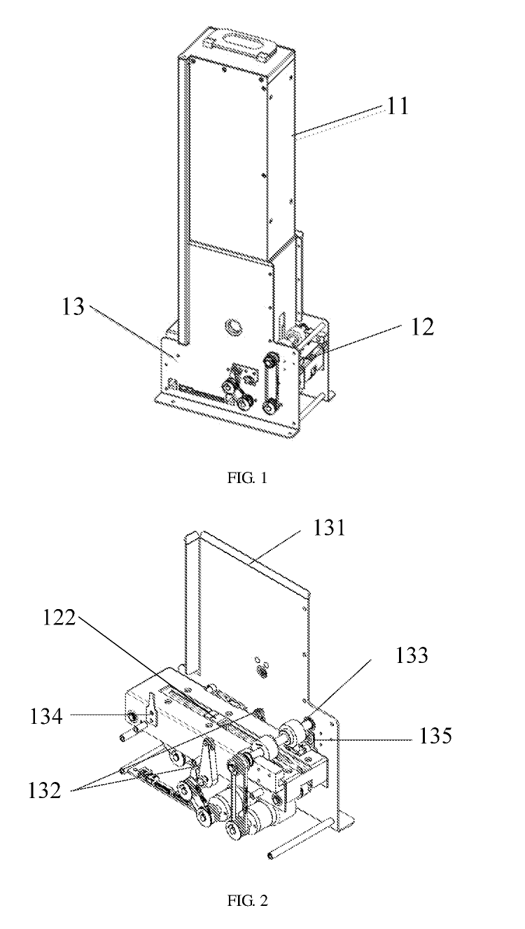

Referring to FIG. 1, a structural block diagram of a card issuing device according to an embodiment of the present invention is illustrated. The card issuing device includes a card storing mechanism 11, a transport mechanism 12 and a base 13. The transport mechanism 12 is arranged in the base 13. The card storing mechanism 11 is arranged above the transport mechanism 12. The card storing mechanism 11 includes a pressing block 112 and a buckle 113. The transport mechanism 12 includes a guide rail 121 and a card hook 122. The transport mechanism 12 transports a card by the cooperating of the guide rail 121 and the card hook 122. The card storing mechanism 11 fixes the card via the pressing block 112 and the buckle 113. The base 13 is configured to fix the card storing mechanism 11 and the transport mechanism 12.

In the embodiment of the present invention, the card is transported by cooperating of the guide rail 121 and the card hook 122, and the guide rail 121 vertically and horizontally limits the card hook 122, such that the card hook 122 is more stable during the movement. By combination of the guide rail 121 and the card hook 122, a card issuing action and a card receiving action may be completed.

Referring to FIG. 2, an interior view of a base 13 according to an embodiment of the present invention is illustrated. The base 13 includes a rack 131, a card receiving top block 132 and a driving wheel 133. The driving wheel 133 is arranged above an initial position of the card hook 122. The driving wheel 133 is configured to cooperate with the card hook 122 to transport the card to the card storing mechanism 11. Specifically, when the card is issued, the card hook 122 is first moved to the rear part of the card storing mechanism 11 (in the process of the movement, to prevent the card hook 122 and the card from interfering with each other, the card receiving top block 132 pushes up the card in the card storing mechanism 11 to allow the card hook 122 to pass smoothly), and then pushes the card to the driving wheel 133. The driving wheel 133 is rotated to take in the card for transmission, and when the card is separated from the transport mechanism 12, the driving wheel 133 stops rotating, and thus the card issuing action is completed. It is to be noted that an accessing card detecting device 135 may be used for determining whether the card is detached from the transport mechanism 12 or determining whether the card is detected. The accessing card detecting device 135 may include an optocoupler component, and a laser displacement sensor component, etc., which is not limited in this embodiment of the present invention. It is to be noted that the accessing card detecting device 135 may be arranged below the driving wheel 133, such that the card can be easily detected.

When the card is recovered, after the card is transported in via the driving wheel 133, the card is pushed by the card hook 122 to the card storing mechanism 11, thus the card receiving action is completed.

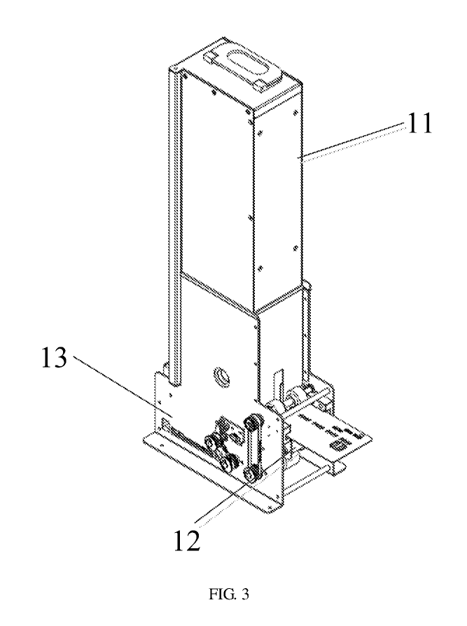

Referring to FIG. 3, a structural block diagram of a card issuing device according to an embodiment of the present invention is illustrated. The transport mechanism 12 is arranged in the base 13. The base 13 includes the driving wheel 133. The card is transported to the card storing mechanism 11 via the driving wheel 133 and the card hook 122. Further, the card may be pushed out of the card storing mechanism 11 via the driving wheel 133 and the card hook 122. The card issuing box and the card receiving box are integrated into one body to reduce structural complexity, reduce costs, and improve space utilization rate.

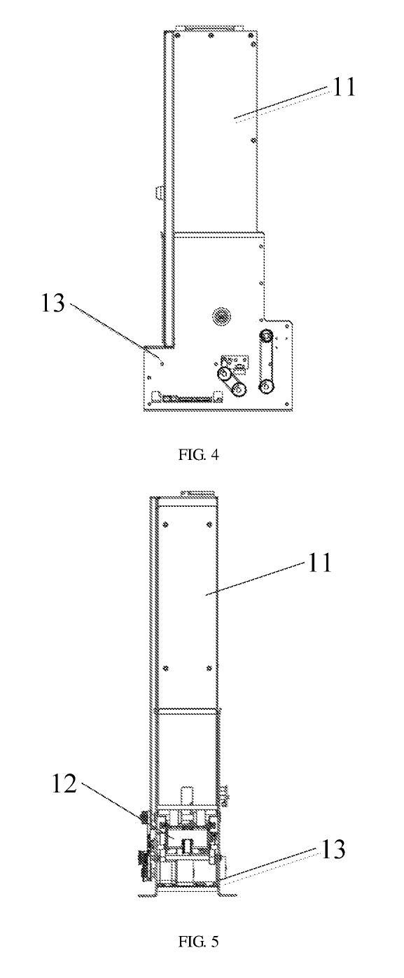

Referring to FIG. 4, a side view of a card issuing device according to an embodiment of the present invention is illustrated. The transport mechanism 12 is arranged in the base 13. The card storing mechanism 11 is arranged above the transport mechanism 12. The structure of the card issuing device is simple and the space utilization rate is improved.

Referring to FIG. 5, a front view of a card issuing device in accordance with an embodiment of the present invention is illustrated. The transport mechanism 12 is arranged in the base 13. The transport mechanism 12 includes a driven wheel 124. The driven wheel 124 and the driving wheel 133 on the base 13 cooperate with each other to receive the card into or push the card out of the card storing mechanism 11. In this way, the structural complexity is reduced, and the costs are reduced.

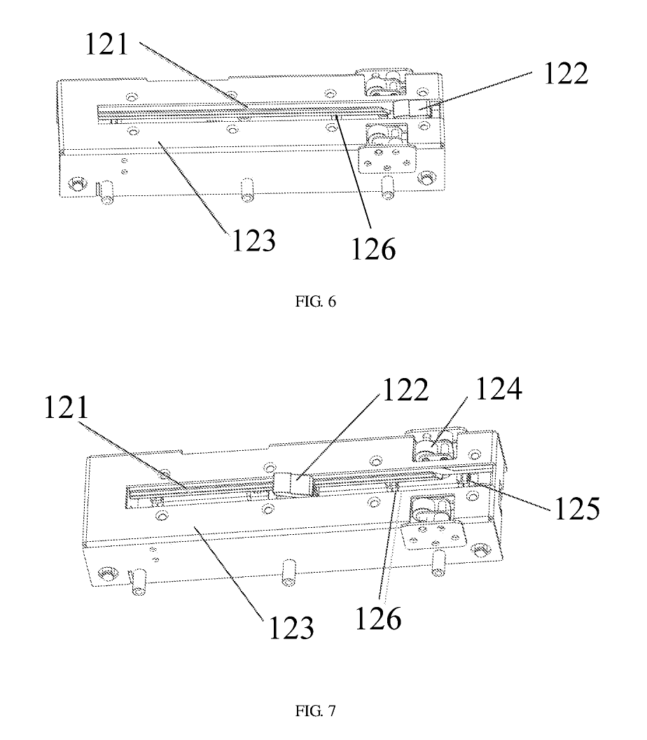

Referring to FIG. 6, a structural block diagram of a transport mechanism 12 according to an embodiment of the present invention is illustrated. The transport mechanism 12 is arranged in the base 13. The card storing mechanism 11 is arranged above the transport mechanism 12. The transport mechanism 12 includes a guide rail 121 and a card hook 122. The transport mechanism 12 transports the card to the card storing mechanism 11 by the cooperating of the guide rail 121 and the card hook 122.

Specifically, in the embodiment of the present invention, the transport mechanism 12 further includes a card issuing seat 123. A center of the card issuing seat 123 has a strip-shaped groove, and the guide rail 121 is embedded on both sides of the strip-shaped groove. The card hook 122 slides via the guide rail 121. Further, the card is placed on the card hook 122, and the card is transported to the card storing mechanism 11 via the guide rail 121.

Referring to FIG. 7, a structural block diagram of a transport mechanism 12 of an embodiment of the present invention is illustrated. The transport mechanism 12 may further include a driven wheel 124. The driven wheel 124 on the transport mechanism 12 and the driving wheel 133 on the base 13 cooperate with each other. The card hook 122 may slide via the guide rail 121 to receive the card into or push the card out of the card storing mechanism 11, thereby reducing the structural complexity and reducing the costs. The transport mechanism further includes a card hook detecting device 125. The card hook detecting device 125 is configured to detect the position of the card hook 122. It is to be noted that the transport mechanism may further include other card hook detecting devices, such as a card hook detecting device 126. The card hook detecting device 125 and the card hook detecting device 126 are arranged at different positions of the strip-shaped groove respectively.

Referring to FIG. 8, a structural block diagram of a card storing mechanism 11 according to an embodiment of the present invention is illustrated. The card storing mechanism 11 further includes a box body 111. The box body 111 includes a mounting plate 1110, a front baffle 1111, a box door 1112, a right side plate 1113 and a left side plate 1114. The right side plate 1113 is connected to the mounting plate 1110 and the box door 1112 respectively. The left side plate 1114 is connected to the mounting plate 1110 and the box door 1112 respectively. The mounting plate 1110 is connected to the front baffle 1111.

Further, in the embodiment of the present invention, the box body 111 further includes a bottom plate 1115 and a top plate 1116. The bottom plate 1115 is located below the front baffle 1111, the right side plate 1113 and the left side plate 1114, and is connected to the front baffle 1111, the right side baffle 1113 and the left side baffle 1114 respectively. The top baffle 1116 is located above the box door 1112, the right side baffle 1113 and the left side baffle 1114, and is connected to the box door 1112, the right side baffle 1113 and the left side baffle 1114 respectively.

Specifically, the pressing block 112 is connected to the mounting plate 1110, and the pressing block 112 moves along the length direction of the mounting plate 1110. The buckle 113 is arranged below the top plate 1116, and the buckle 113 is configured to unlock or lock the pressing block 112. When the card is received into the card storing mechanism 11, the pressing block 112 moves up to the top of the card storing mechanism 11, and the buckle 113 locks the pressing block 112, such that the card may be conveniently placed in the card storing mechanism 11. When the box door 1112 is closed, the buckle 113 is triggered to unlock the pressing block 112, and the pressing block 112 presses the card to prevent the card from swaying. The card storing mechanism 11 may further include a box door clamping plate 114. The box door clamping plate 114 is provided with a movable fixing device 1141 distributed along the length direction of the box door clamping plate 114, wherein the movable fixing device may include a locking piece or a cylinder locking strip and so on, which is not limited by the embodiment of the present invention.

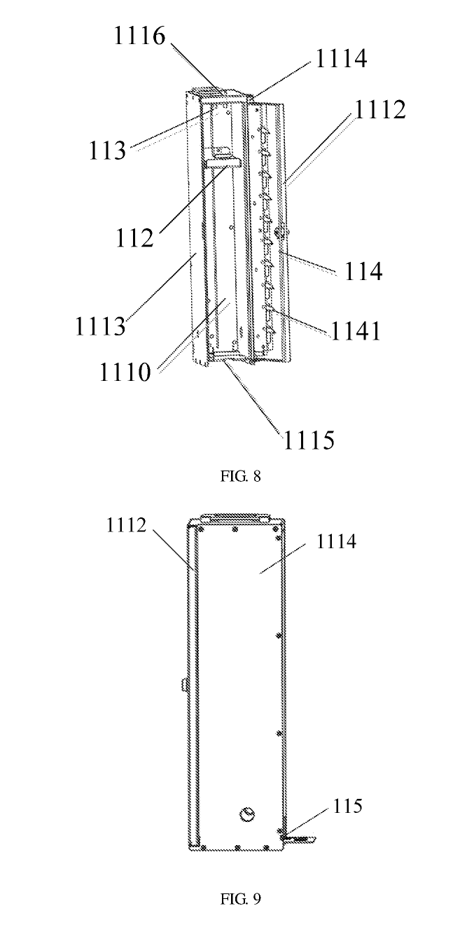

Referring to FIG. 9, a side view of a card storing mechanism 11 according to an embodiment of the present invention is illustrated. The card storing mechanism 11 further includes a card issuing port 115. The card is transported to the card storing mechanism 11 via the card issuing port 115 or is pushed out of the card storing mechanism 11 via the card issuing port 115.

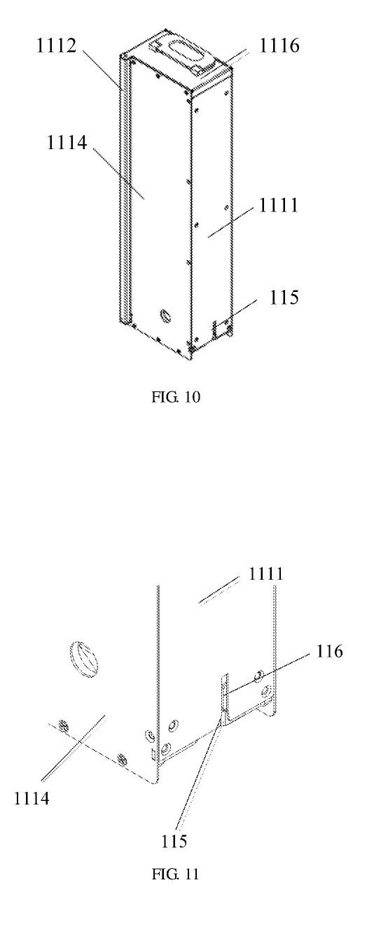

Referring to FIG. 10, a structural block diagram of a card storing mechanism 11 according to an embodiment of the present invention is illustrated. Referring to FIG. 11, a partial view of a card storing mechanism 11 according to an embodiment of the present invention is illustrated. The card storing mechanism 11 further includes a card issuing baffle 116. The card issuing baffle 116 is arranged in the card issuing port 115 of the mounting plate 1110. The card issuing baffle 116 is configured to prevent the card from slipping out of the card storing mechanism 11. A left blocking card block/a right blocking card block is further arranged at the card issuing port below the mounting plate 1110, to adjust a card issuing gap.

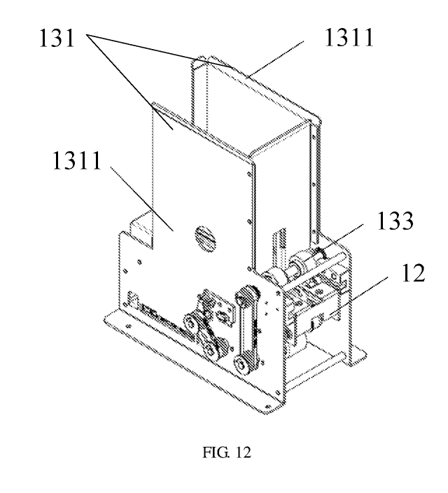

Referring to FIG. 12, a structural block diagram of a base 13 according to an embodiment of the present invention is illustrated. The base 13 includes a rack 131, a card receiving top block 132, and a driving wheel 133. The driving wheel 133 is arranged above the initial position of the card hook 122, and the driving wheel 133 is configured to cooperate with the card hook 122 to transport the card to the card storing mechanism 11.

In a preferred embodiment of the present invention, as shown in FIG. 2, the card receiving top block 132 is arranged on two sides of the rack 131. The card receiving top block 132 is configured to push up the card in the card storing mechanism 11. The base 13 further includes an unlocking block 134. The unlocking block 134 is configured to receive the movable fixing device 1141 into the box door clamping plate after the card storing mechanism 11 is placed into the base 13. In this way, it is convenient to recycle the card. Further, the rack 131 includes a rack plate 1311 on both sides thereof. The rack plate 1311 is configured to fix the card storing mechanism and the transport mechanism. Therefore, the structure is simple, the space utilization rate is improved, the structural complexity is reduced, and the costs are reduced.

Finally it should be explained that a relational term (such as a first or a second . . . ) is merely intended to separate one entity or operation from another entity or operation instead of requiring or hinting any practical relation or sequence exists among these entities or operations. Furthermore, terms such as “comprise”, “include” or other variants thereof are intended to cover a non-exclusive “comprise” so that a process, a method, a merchandise or a terminal device comprising a series of elements not only includes these elements, but also includes other elements not listed explicitly, or also includes inherent elements of the process, the method, the merchandise or the terminal device. In the case of no more restrictions, elements restricted by a sentence “include a . . . ” do not exclude the fact that additional identical elements may exist in a process, a method, a merchandise or a terminal device of these elements.

The above describes in detail a card issuing device provided by an embodiment of the present invention, elaboration of principles and implementations of the embodiment of the present invention is made by using specific examples herein, and the description of the foregoing embodiment is merely intended to assist in understanding the method of the embodiment of the present invention and the core concept thereof. Also, those of ordinary skill in the art may change, in according with the concept of the embodiment of the present invention, a concrete implementation and a scope of application. In conclusion, contents of the specification shall be not interpreted as limiting the embodiment of the present invention.

What is claimed is:

1. A card issuing device, comprising: a card storing mechanism, a transport mechanism and a base; wherein the transport mechanism is arranged in the base; the card storing mechanism is arranged above the transport mechanism; the card storing mechanism comprises a pressing block and a buckle; the transport mechanism comprises a guide rail and a card hook; the transport mechanism transports a card by cooperating of the guide rail and the card hook; the card storing mechanism fixes the card via the pressing block and the buckle; and the base is configured to fix the card storing mechanism and the transport mechanism.

2. The card issuing device according to claim 1, wherein the card storing mechanism further comprises a box body; the box body comprises a mounting plate, a front baffle, a box door, a right side plate and a left side plate; the right side plate is connected to the mounting plate and the box door, respectively; the left side plate is connected to the mounting plate and the box door, respectively; and the mounting plate is connected to the front baffle.

3. The card issuing device according to claim 2, wherein the box body further comprises a bottom plate and a top plate; the bottom plate is located below the front baffle, the right side plate and the left side plate, and is connected to the front baffle, the right side plate and the left side plate, respectively; and the top plate is located above the box door, the right side plate and the left side plate, and is connected to the box door, the right side plate and the left side plate, respectively.

4. The card issuing device according to claim 2, wherein the pressing block is connected to the mounting plate, the pressing block moves along a length direction of the mounting plate; the buckle is arranged below the top plate, and the buckle is configured to unlock or lock the pressing block.

5. The card issuing device according to claim 1, wherein the transport mechanism further comprises a card issuing seat; a center of the card issuing seat has a strip-shaped groove, the guide rail is embedded on two sides of the strip-shaped groove; and the card hook slides via the guide rail.

6. The card issuing device according to claim 5, wherein the card is placed on the card hook, and the card is transported to the card storing mechanism via the guide rail.

7. The card issuing device according to claim 1, wherein the base comprises a rack, a card receiving top block and a driving wheel; the driving wheel is arranged above an initial position of the card hook; and the driving wheel is configured to cooperate with the card hook to transport the card to the card storing mechanism.

8. The card issuing device according to claim 7, wherein the card receiving top block is arranged on both sides of the rack; and the card receiving top block is configured to push up the card in the card storing mechanism.

9. The card issuing device according to claim 8, wherein the rack comprises rack plates on both sides thereof, and the rack plate is configured to fix the card storing mechanism and the transport mechanism.

10. The card issuing device according to claim 2, wherein the card storing mechanism further comprises a card issuing baffle; the card issuing baffle is arranged in a card issuing port of the mounting plate; and the card issuing baffle is configured to prevent the card from slipping out of the card storing mechanism.

What is claimed is:

1. A card issuing device, comprising: a card storing mechanism, a transport mechanism and a base; wherein the transport mechanism is arranged in the base; the card storing mechanism is arranged above the transport mechanism; the card storing mechanism comprises a pressing block and a buckle; the transport mechanism comprises a guide rail and a card hook; the transport mechanism transports a card by cooperating of the guide rail and the card hook; the card storing mechanism fixes the card via the pressing block and the buckle; and the base is configured to fix the card storing mechanism and the transport mechanism.

2. The card issuing device according to claim 1, wherein the card storing mechanism further comprises a box body; the box body comprises a mounting plate, a front baffle, a box door, a right side plate and a left side plate; the right side plate is connected to the mounting plate and the box door, respectively; the left side plate is connected to the mounting plate and the box door, respectively; and the mounting plate is connected to the front baffle.

3. The card issuing device according to claim 2, wherein the box body further comprises a bottom plate and a top plate; the bottom plate is located below the front baffle, the right side plate and the left side plate, and is connected to the front baffle, the right side plate and the left side plate, respectively; and the top plate is located above the box door, the right side plate and the left side plate, and is connected to the box door, the right side plate and the left side plate, respectively.

4. The card issuing device according to claim 2 or 3, wherein the pressing block is connected to the mounting plate, the pressing block moves along a length direction of the mounting plate; the buckle is arranged below the top plate, and the buckle is configured to unlock or lock the pressing block.

5. The card issuing device according to claim 1, wherein the transport mechanism further comprises a card issuing seat; a center of the card issuing seat has a strip-shaped groove, the guide rail is embedded on two sides of the strip-shaped groove; and the card hook slides via the guide rail.

6. The card issuing device according to claim 5, wherein the card is placed on the card hook, and the card is transported to the card storing mechanism via the guide rail.

7. The card issuing device according to claim 1 or 5, wherein the base comprises a rack, a card receiving top block and a driving wheel; the driving wheel is arranged above an initial position of the card hook; and the driving wheel is configured to cooperate with the card hook to transport the card to the card storing mechanism.

8. The card issuing device according to claim 7, wherein the card receiving top block is arranged on both sides of the rack; and the card receiving top block is configured to push up the card in the card storing mechanism.

9. The card issuing device according to claim 8, wherein the rack comprises rack plates on both sides thereof, and the rack plate is configured to fix the card storing mechanism and the transport mechanism.

10. The card issuing device according to claim 2 or 3, wherein the card storing mechanism further comprises a card issuing baffle; the card issuing baffle is arranged in a card issuing port of the mounting plate; and the card issuing baffle is configured to prevent the card from slipping out of the card storing mechanism.
